(19) United States
(12) Patent Application Publication
(10) Pub. No.: US 2014/0212695 A1
(43) Pub. Date: Jul. 31, 2014

(54) FLEXIBLE PRINTED CIRCUIT AS HIGH VOLTAGE INTERCONNECT IN BATTERY MODULES

(71) Applicant: TESLA MOTORS, INC., Palo Alto, CA (US)

(72) Inventors: Robert Clinton Lane, San Jose, CA (US); Jeff Weintraub, San Carlos, CA (US)

(73) Assignee: TESLA MOTORS, INC., Palo Alto, CA (US)

(21) Appl. No.: 13/754,843

(22) Filed: Jan. 30, 2013

(51) Int. Cl. H01M 2/20

(52) U.S. Cl. CPC H01M 2/202; H01M 2/204; H01M 2/206
USPC 429/7

(57) ABSTRACT

A system and method for improving on conventional techniques for connecting energy storage elements of a high-voltage battery pack. A tuned flexible printed circuit individually coupled to each electrode of each cell of a matrix of cells of the battery pack provides improved manufacturability and reliability.

### FIELD OF THE INVENTION

The present invention relates generally to high-voltage chargeable battery packs, and more specifically, but not exclusively, to high-voltage current connection of energy storage elements of the high-voltage chargeable battery packs.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Battery packs, for purposes of this disclosure, include a plurality of series-connected battery elements. These elements may, in turn, include a parallel, series, or combination of both, collection of chargeable energy storage cells, usually rechargeable cells. Collectively all these cells store energy for the battery pack. The series-connected battery elements may, in turn be subdivided into collections of modules, each module including one or more series-connected battery elements.

In many instances, the battery pack may be treated as a monolithic unit, providing energy for operation of an external device. However, to enable such treatment, individual cells, series-elements, and modules are processed in order to achieve a desired average monolithic effect. This effect is achieved in part by use of modular assembly techniques, including assembly of the modules. These modular assembly techniques produce very dense energy profiles that can be susceptible to manufacturing and operational events that may compromise operation or safety.

To improve reliability and manufacturability of modules that are resistant to such manufacturing and operational event, the modules and their assembly has become refined and sophisticated. Features of these modules and module assembly include use of large numbers of cells captured in a double clamshell assembly to form arrays of closely spaced cells. Each cell of the array is included in a cylindrical metal package with a cathode at one end and an anode at the other end. There are specialized machines that organize and orient each cell for loading into the clamshells. The orientation is important as the cells are collected into parallel and series connected groups to achieve the final desired voltage and current requirements. One collector plate is secured over the bottom ends (which may include a combination of cathodes and anodes) and another collector plate is secured over the top ends (which also may include a combination of cathodes and anodes). There are apertures in the collector plates corresponding to an end of each cell where a thin copper conductor is wire-bonded to the collector plate and the electrical terminal exposed in the aperture.

Manufacturability, reliability, and resource costs (weight, size, and money) are implicated by this design in many ways, including the following. The wire-bonded wires provide important fusing structures. However, conventional wire-bond techniques make the wire very susceptible to breaking whenever there is small amplitude relative motion between the collector plate and the end of the cell exposed in the aperture. Being fuses, and because there is a susceptibility to breakage, there are various randomized disconnects in each module array. These disconnects produce current patterns in the collector plates that are difficult to model and assess accurately. Consequently the collector plate must be made relatively thick to support maximum current density patterns.

To restrict the relative movement of the ends of the cells in the clamshells, adhesive potting techniques are developed and refined to accurately and economically hold the ends of the cells in place. These potting techniques can be expensive and time-consuming, particularly when it is desired to reduce the curing time of the adhesive and to ensure that adhesive does not leak out and interfere with the wire-bonding operations that are to come. The adhesive adds extra weight to each module but reducing the adhesive without care can increase relative motion of the ends of the cells that risks breakage of the wire-bonds.

For cylindrical cells, a great deal of heat is transferred through the ends of the cells. The modules may not be cooled using the end of the cells when the collector plates are disposed at each end. The modules thus provide cooling channels in the clamshells that cool the sides of the cells. The cells may not be packed as densely as they could be without these channels and if the cooling were more efficient.

Each module includes an independent electronics module (a battery module board or BMB) that includes a processor and transceivers for collecting information about a status of the cells of a module, transmitting status, and receiving commands. It is desirable to collect information (e.g., temperature, voltage, and the like) on the status of the cells and to transmit that status information to a battery management system. With the existing module design, a separate temperature and voltage external wiring harness is used to connect the separate BMB to the sensors. These harnesses add to complexity and decrease manufacturability.

What is needed is a system and method for improving on conventional techniques for connecting energy storage elements of a high-voltage battery pack.

### BRIEF SUMMARY OF THE INVENTION

Disclosed is a system and method for improving on conventional techniques for connecting energy storage elements of a high-voltage battery pack. The following summary of the invention is provided to facilitate an understanding of some of technical features related to use of a flexible printed circuit as a high-voltage current transfer medium in a battery pack, and is not intended to be a full description of the present invention. A full appreciation of the various aspects of the invention can be gained by taking the entire specification, claims, drawings, and abstract as a whole. The present invention is applicable to other implementations in addition to electric vehicles and to other arrangements of series-connected energy storage elements.

An energy storage module, including: a matrix of energy storage elements orderly arranged and secured into a plurality of N number of rows and M number of columns, N greater than or equal to M, each energy storage element of the matrix including a surface face defining both a positive terminal and a negative terminal; and a flexible printed circuit having a flexible conductive layer disposed between a pair of flexible insulating layers, each the layer having a thickness less than 0.1 mm, the conductive layer defining a flexible interconnect pattern, the interconnect pattern including a plurality of bulk conductor regions, each bulk conductor region disposed parallel to the rows and associated with a set of energy storage elements, with each bulk conductor region including a plurality of positive terminal contacts joined to the positive terminals of the associated set of energy storage elements using a mechanical joint and a plurality of negative terminal contacts joined to the negative terminals of the associated set of energy storage elements using the mechanical joint; wherein the interconnect pattern couples the plurality of energy storage elements into a single electrical module including both parallel-connected and series-connected sub-divisions of the plurality of energy storage elements.

An energy storage module, including: a matrix of energy storage elements orderly arranged and secured into a plurality of N number of rows and M number of columns, N greater than or equal to M, each energy storage element of the matrix including a surface face defining both a positive terminal and a negative terminal; and a flexible printed circuit having one or more flexible conductive layers disposed between alternating flexible insulating layers, each the layer having a thickness less than 0.1 mm, each the conductive layer defining a flexible interconnect pattern, the interconnect patterns collectively including a plurality of bulk conductor regions, each bulk conductor region disposed parallel to the rows and associated with a set of energy storage elements, with each bulk conductor region including a plurality of positive terminal contacts joined to the positive terminals of the associated set of energy storage elements using a mechanical joint and a plurality of negative terminal contacts joined to the negative terminals of the associated set of energy storage elements using the mechanical joint; wherein the interconnect patterns collectively couple the plurality of energy storage elements into a single electrical module including both parallel-connected and series-connected sub-divisions of the plurality of energy storage elements.

An energy storage module, including: a matrix of energy storage elements orderly arranged and secured into a plurality of N number of rows and M number of columns, N greater than or equal to M, each energy storage element of the matrix including a surface face defining both a positive terminal and a negative terminal; and a flexible printed circuit having a first region including a flexible conductive layer disposed between a pair of flexible insulating layers and a second region including a plurality of conductive layers disposed between alternating flexible insulating layers, each the conductive layer defining a flexible interconnect pattern, the interconnect pattern of the first region providing terminal connection structures including a plurality of positive terminal contacts joined to the positive terminals of the associated set of energy storage elements using a mechanical joint and a plurality of negative terminal contacts joined to the negative terminals of the associated set of energy storage elements using the mechanical joint, and the interconnect patterns of the second region collectively including a plurality of bulk conductor regions, each bulk conductor region disposed parallel to the rows and associated with a set of energy storage elements, with each bulk conductor region electrically communicated to the first region; wherein the interconnect patterns collectively couple the plurality of energy storage elements into a single electrical module including both parallel-connected and series-connected sub-divisions of the plurality of energy storage elements.

An energy storage module, including: a matrix of energy storage elements orderly arranged and secured into a plurality of N number of rows and M number of columns, N greater than or equal to M, each energy storage element of the matrix including a first surface face defining a positive terminal and second surface face defining a negative terminal; and a pair of flexible printed circuits, each flexible printed circuit having a flexible conductive layer disposed between a pair of flexible insulating layers, each the layer having a thickness less than 0.1 mm, the conductive layer defining a flexible interconnect pattern, the interconnect pattern including a plurality of bulk conductor regions, each bulk conductor region disposed parallel to the rows and associated with a set of energy storage elements, with each bulk conductor region including a plurality of terminal contacts; wherein the terminals of the associated set of energy storage elements are electrically communicated to one of the flexible printed circuits using a plurality of mechanical joints between the terminals and the terminal contacts.

A method of interconnecting a matrix of energy storage elements orderly arranged and secured into a plurality of N number of rows and M number of columns, N greater than or equal to M, each energy storage element of the matrix including one or two surface faces defining a positive terminal and a negative terminal, including: a) overlying all the terminals with one or two flexible printed circuits, one flexible printed circuit assembly for each face defining a terminal; and b) mechanically joining the one or two flexible printed circuits to each terminal of each energy storage element creating an electrical coupling of the flexible printed circuit boards to the matrix of energy storage elements.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a side view of an interconnected array of energy storage elements;

FIG. 2 illustrates a detail of a pair of energy storage elements from FIG. 1;

FIG. 3 illustrates a top view of a representative array of energy storage elements;

FIG. 4 illustrates a flexible printed circuit for use as an inter-connecting system for the energy storage elements of FIG. 3;

FIG. 5 illustrates use of the flexible printed circuit of FIG. 4 in conjunction with the array of energy storage elements of FIG. 3;

FIG. 6 illustrates a representative flexible printed circuit interconnected module directly supporting a battery module board, and low voltage communication lines communicating with cell sensors; and

FIG. 7 illustrates a portion of a flexible printed circuit including a contact joined to a bulk conductor region using a flexible fusible link.

### DETAILED DESCRIPTION OF THE INVENTION

Embodiments of the present invention provide a system and method for improving on conventional techniques for connecting energy storage elements of a high-voltage battery pack. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

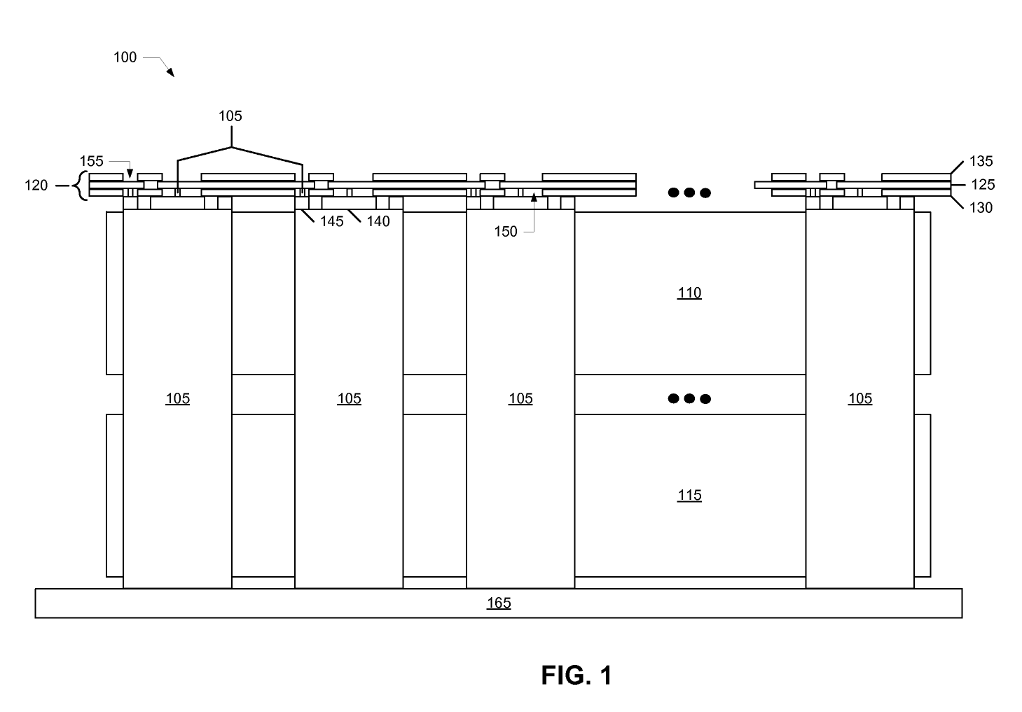

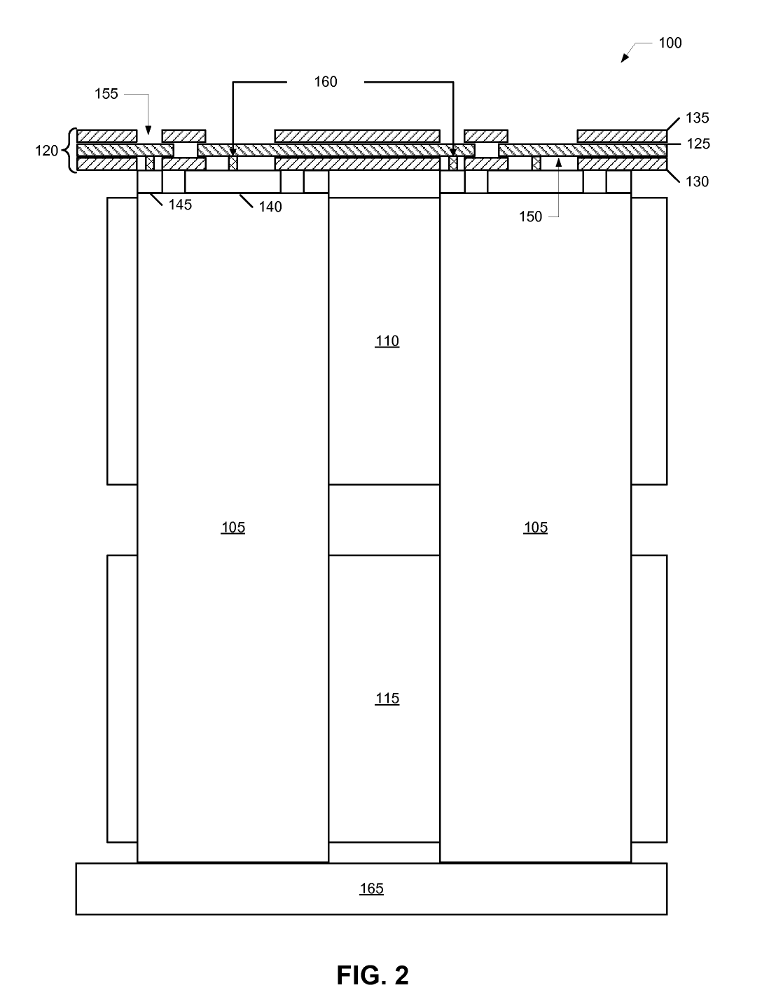

FIG. 1 illustrates a side view of an interconnected array 100 of energy storage elements 105. FIG. 2 illustrates a detail of a pair of energy storage elements 105. Elements 105 are physically secured and held in place by a pair of opposing clamshells—a top clamshell 110 and a bottom clamshell 115. A flexible printed circuit 120 overlies and connects the electrical terminals of energy storage elements 105. Flexible printed circuit 120 includes three layers: a flexible conductive layer 125 sandwiched between a flexible bottom insulating layer 130 and a flexible top insulating layer 135. For example, the conducting layer is typically a uniform layer of metal such as copper and the insulating layers are uniform layers of polyimide (e.g., Kapton®), though other materials may be used in lieu of or in combination with these representative materials.

Design and construction of flexible printed circuits are well-known, including techniques for patterning. Patterning of conductive layer 125 is used to provide a desired electrical circuit forming desired aggregations of parallel and series connected energy storage elements. Parallel combinations increase current and series combinations increase voltage output. Constructing a battery pack to produce 400 Volts or more at 1000 Amperes or more using 4 Volt nominal energy storage elements 105 requires many interconnections of many elements (e.g., thousands). Typically not all the elements of a battery pack are contained within a single physical array. They are commonly divided into modules, each having hundreds of elements 105. The modules are then electrically joined and secured within an enclosure that provides protection from the environment. The disclosed embodiment lends itself to scaling for arrays of virtually any number of energy storage elements 105.

Energy storage elements 105 are a type of rechargeable secondary battery cell having a flat top with its terminals at one end. Each energy storage element 105 thus includes a center positive terminal 140 and a surrounding annular negative terminal 145. The patterning of flexible printed circuit 120 produces die cut areas 150 in bottom insulating layer 130 to allow exposed portions of conductive layer 125 to make electrical contact, such as to connect selectively to the terminals of energy storage element 105. Die cut areas 155 in top insulating layer 135 allow exposed portions of conductive layer 125 to receive a device that produces an electromechanical connection between the portion of conductive layer interacting with the device and the underlying surface to be joined (e.g., a terminal of an energy storage element 105). There are many different types of devices and techniques that may be used and adapted for this process to make electromechanical joints, some of which are well-known. For example, the embodiment illustrated in FIG. 1 includes a plurality of spot welds 160 joining portions of conductive layer 125 to various terminals of individual energy storage elements 105.

Providing all electrical connections to energy storage elements 105 at one end enables a cooling system 165 to be directly coupled to the other end. Cooling of energy storage elements 105 is more efficient at an end, and the arrangement illustrated in FIG. 1 enables simple efficient cooling of energy storage elements 105. Cooling system 165 may include coolant loops with heat exchangers, heat pumps, and the like. Using a more efficient cooling paradigm enables the construction and arrangement of modules and coolant loops within the enclosure to be redesigned, further improving certain of the supporting systems. These may produce additional savings and advantages in addition to the specific savings and advantages described herein.

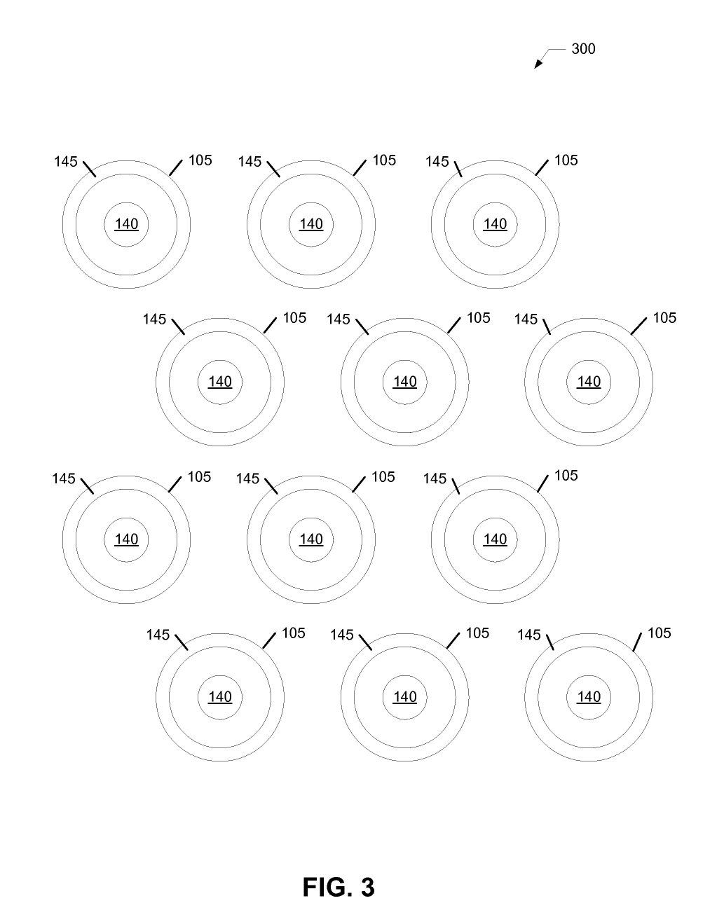

FIG. 3 illustrates a top view of a representative array 300 of energy storage elements 105 such as those illustrated in FIG. 1. Each energy storage element 105 includes center positive terminal 140 and surrounding annular negative terminal 145. FIG. 3 illustrates use of an 18650 form factor Li-Ion secondary battery cell, though other form factors having both electrical terminals on one side of a cell package may be used with the present invention. Actual packing density is determined by implementation details, including temperature changes during operation and cooling efficiency. In FIG. 3, energy storage elements 105 may be packed closely to a next nearest neighboring energy storage element, spacing dependent upon several design factors including cell pitch, cooling modality and efficiency, and operating parameters.

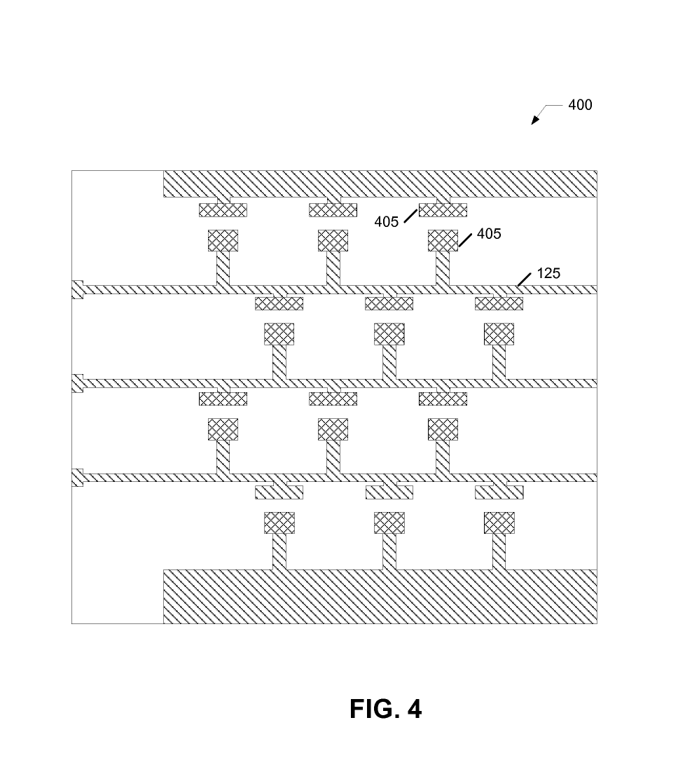

FIG. 4 illustrates a top view of a representative flexible printed circuit 400 for use as an inter-connecting system for the energy storage elements of FIG. 3. Flexible printed circuit 400 is an example of flexible printed circuit 120 illustrated in FIG. 1. The single hatched regions of flexible printed circuit 400 represent a pattern for conductive layer 125 illustrated in FIG. 1. The double-hatched regions of flexible printed circuit 400 represent pads for terminal contacts 405 which will be joined to the electrical terminals of energy storage elements 105. Some joining techniques may use a pre-join processing to improve the joining technique. For example, the contact pads of flexible printed circuit 400 are plated, such as will nickel, in order to support spot welding of the contact pads to the electrical terminals. There is a manufacturing trade-off as to how thick to make the nickel plating. A thicker plating provides better performance but is more expensive. Some implementations may use a different material or a different pre-join processing, dependent upon implementation and the joining technique to be employed.

Conductive layer 125 is manufactured from 1 oz. copper (0.035 mm thick) that is designed to be flexible and robust, at least partially due to the dual insulating polyimide layers on each side. In contrast, a direct collector plate equivalent thickness of copper would be 0.5 mm thick. The innovations of the customized and tailored patterning as further explained below permit the actual thickness of conductive layer 125 to much less than a straight-forward substitution would suggest is necessary.

The patterning of conductive layer 125 may be quite elaborate and complex to achieve the desired interconnect pattern and to inherently provide some of the elements previously implemented by discrete elements in conventional systems. For example, a conventional aluminum collector plate would have thin wires bonded between the collector plate and individual terminals of the battery cells. These thin wires were made of a material that was sized to provide the desired fusing action in response to certain circuits.

Neck portions of terminal contacts 405 are sized (e.g., narrowed) to achieve the desired fusing requirements. Thus each contact pad is joined to larger current carrying regions of flexible printed circuit 400 by fusible neck portions. In the conventional systems with collector plates, the bonded wires had a sensitivity to relative displacements of the underlying ends of the battery cells. This was one of the reasons that the potting techniques were developed and improved, to help secure the battery cells within the clamshells against small displacement amplitudes.

The fusible neck portions of flexible printed circuit 400 have a greatly reduced sensitivity to such displacements. The entire underlying manufacturing paradigm of the flexible printed circuit (also sometimes referred to as “flex circuits) includes an entire technology field for assembling electronic circuits by mounting devices on flexible plastic substrates (e.g., polyimide, PEEK, transparent conductive polyester film, and the like). Some technology features that can be used in embodiments of the present invention include screen printed conductive (e.g., silver) circuits on polyester. The thin copper layer (0.035 mm) captured between two insulating layers (that can be 0.05 mm thick) allow the fusible neck portions to be sufficiently flexible and robust and immune to the types of displacements that could cause manual breakage faults for bonded wire fuses.

Further, because a greater degree of relative displacement is possible, embodiments of the present invention may greatly reduce and/or eliminate the use of potting to secure energy storage elements 105 within the array.

There is yet another manufacturing advantage achieved by use of flexible printed circuit 400. In those modules employing battery cells with a terminal at each end, manufacturing was more complicated. Battery cells from a manufacturer arrive at an assembly location with all the cells oriented in a single direction. Previously special manufacturing techniques and robotics were developed to move these cells into the clamshells because some cells had to be flipped over depending upon what location in the clamshell they were to populate. Ensuring that the cells were properly oriented when loaded into the clamshells added to the complexity of the module assembly process. In these embodiments, there is no requirement for flipping any of the energy storage elements 105.

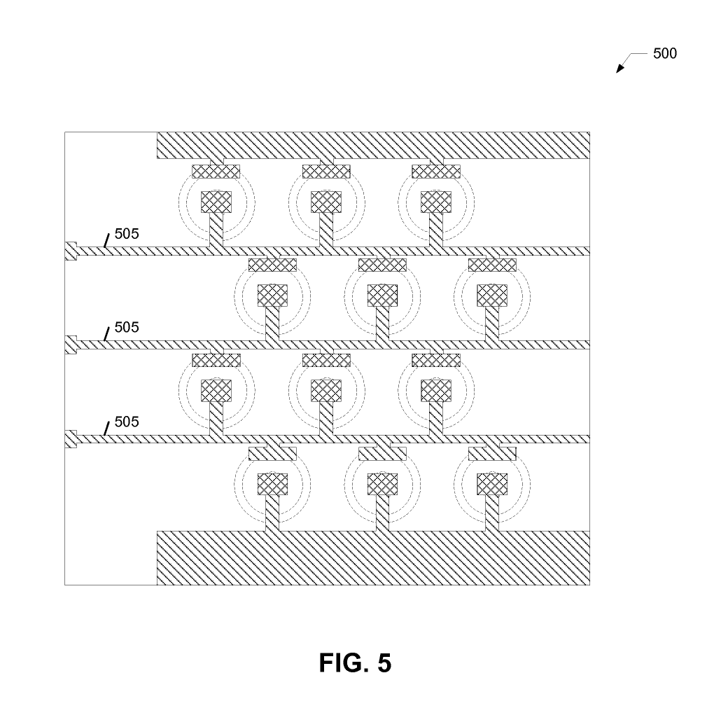

FIG. 5 illustrates use of the flexible printed circuit of FIG. 4 in conjunction with the array of energy storage elements of FIG. 3 to produce a representative flexible printed circuit interconnected module 500. A set of bulk conductor regions 505 optimize current density equally along the longest path possible (for ease of illustration, bulk conductor regions are not shown to scale—actual dimensions are determined based on supporting the current density in each region). A cross-sectional area requirement for current transfer is met by making an aspect ratio very large. Regions 505 define groups of parallel energy storage elements known as “bricks” are laid out as long uniform arrays to maximize robotic joining techniques and make the preferred method as efficient as possible. Regions 505 used to bus current between flexible fusible neck portions carry main bulk of current in plane when a fusible link opens.

The advantages detailed above with respect to 1 oz. copper and robust flexible copper fusible links include: a) minimizing loads experienced by the welds, b) removing cell-to-cell potting, c) removing collector plates, d) removing adhesive that attached collector plates to the cell array, and e) removing wire bonds.

There are additional features and benefits that may be achieved with embodiments of the present invention. Each module is provided with a battery module board that is conventionally implemented as a separate printed circuit board assembly that has a wire harness assembly integrating it into the module power electronics. One of the uses of the battery module board is to communicate with a battery management system providing status information regarding the energy storage elements 105. In a high-voltage electric vehicle operating environment, important status information includes temperature and voltage sense signals communicated over low voltage telemetry lines. In a conventional system, separate wiring harnesses were used to interconnect temperature and voltage sensors to the battery module boards.

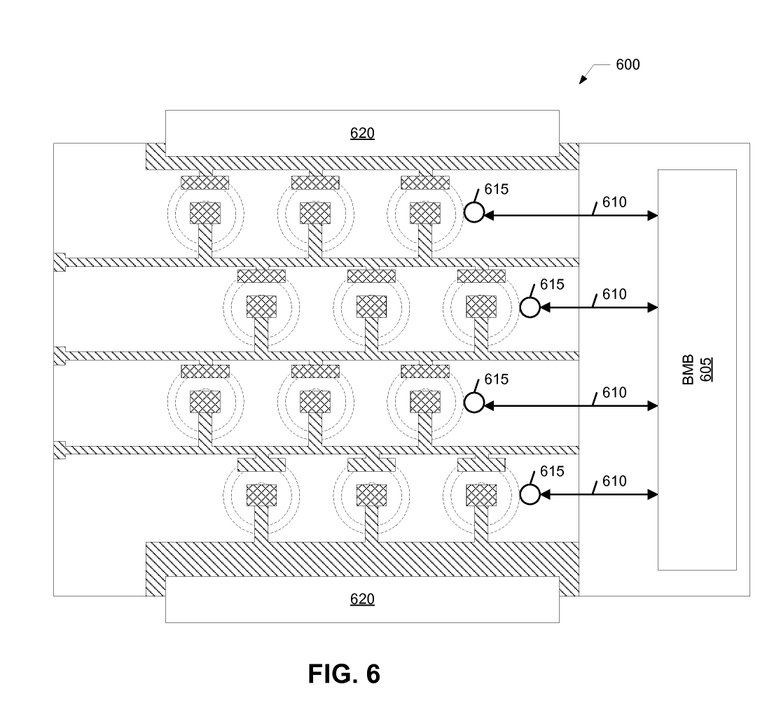

The technology associated with flexible printed circuits enables the components of the battery module board to be incorporated directly into an alternative flexible printed circuit interconnected module. FIG. 6 illustrates a representative flexible printed circuit interconnected module 600 directly supporting a battery module board 605, and low-voltage communication lines 610 communicating with energy storage element sensors 615 (e.g., temperature and voltage). The flex circuit not only supports the BMB functions that are directly incorporated into module 600, but other circuitry of a battery pack that exist on interconnected rigid printed circuit boards may also be added. Low-voltage communications lines 610 and sensors 615 are illustrated in FIG. 6 to convey the use of LV and HV lines in the same module while also illustrating the ability to provide the necessary interconnections without a separate wiring harness. Actual patterning to provide for interconnection to sensors distributed throughout an array will likely be more complex to optimize the various parameters bearing on the design and layout of any particular module 600.

To simplify manufacturing further and improve reliability, connections to module 600 may be made as other printed circuit boards and include large-area PCB-type connectors 620. Connector 620 provides module-to-module interconnects and helps to achieve margin. For example, a right-angle connector extends perpendicularly from a plane containing the conductive layers and may be used for module-to-module interconnecting by extending a flex jumper or the like from these connectors to other connectors on other modules.

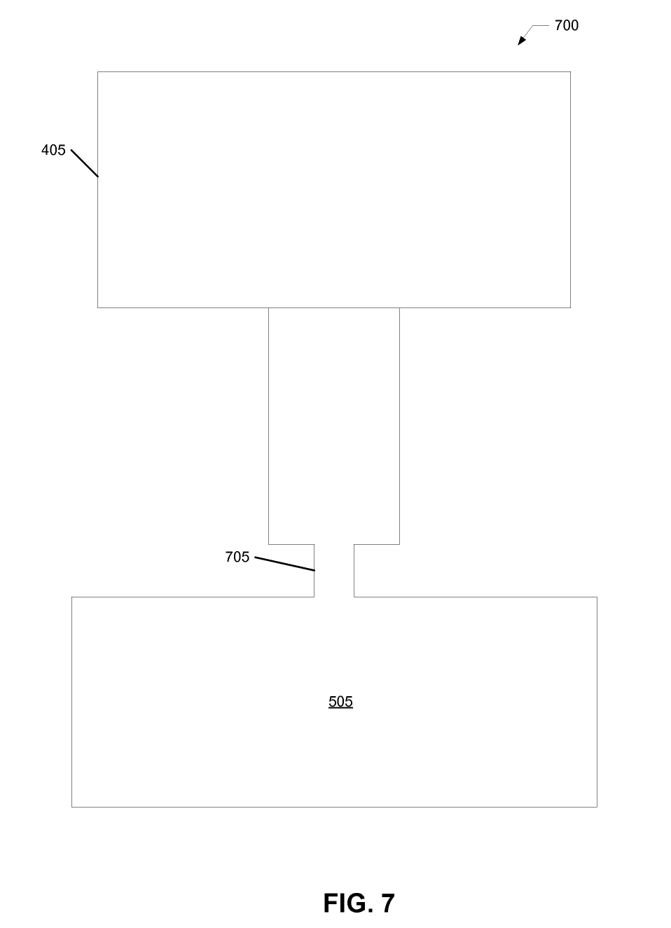

FIG. 7 illustrates a portion of a flexible printed circuit 700 including a terminal contact 405 connected to a bulk conductor region 505 using a flexible fusible link 705. Flexible fusible link 705 is a narrowed region of conductive layer 125 disposed between supporting layers including flexible insulating layer 130 and flexible insulating layer 135. The thickness, length and width of flexible fusible link 705 are determined from the current characteristics of energy storage element 105 and the fuse characteristics to be implemented. A feature of flexible fusible link 705 is that it decouples mechanical loads on the mechanical joint (e.g., spot weld) between terminal contact 405 and the particular terminal of energy storage element 105. This decoupling helps to prevent unintended mechanical failures and allows greater tolerances for a range of motion of the ends of energy storage elements 105.

The embodiments illustrated in FIG. 1-FIG. 7 are simply representative of one implementation type that achieves several synergistic improvements over existing technologies. The present invention is applicable to implementations that do not include all these improvements. For example, in some implementations, energy storage elements having terminals at opposing ends may be used. In such cases, each end of the energy storage elements may be contacted by its own connector assembly, one assembly for each end.

In other implementations, it may be necessary or desirable, for example due to connection detail, current requirements, circuit component connection requirements, to use more than one conductive layer in a flexible printed circuit assembly. In some implementations, a connector design is artificially limited and unnecessarily inefficient or non-optimum when using a single layer of one ounce copper. When a design permits, a single 1 oz. copper layer is preferred. Some embodiments use multilayer flexes for bigger cross sections, these layers are selectively joined with plated through holes, these holes may be located very close to the fusible links. For example, some implementations may use a single layer in one region and use a multilayer of 5 or 6 one oz. layers or 2 or 3 two oz. layers in other regions, with a plated through hole near the single layer of one or two oz., to couple the multilayer regions to the single layer regions, such locations as appropriate (e.g., in the application shown in FIG. 1-FIG. 7, near the fusible link(s) that make a connection to the energy storage element). This generalized architecture provides solutions to overcome many packaging problems, but comes with a cost of greater complexity and manufacturing requirements, as a single layer is preferred when appropriate.

The system and methods above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. An energy storage module, comprising:
a matrix of energy storage elements orderly arranged and secured into a plurality of N number of rows and M number of columns, N greater than or equal to M, each energy storage element of said matrix including a surface face defining both a positive terminal and a negative terminal; and
a flexible printed circuit having a flexible conductive layer disposed between a pair of flexible insulating layers, each said layer having a thickness less than 0.1 mm, said conductive layer defining a flexible interconnect pattern, said interconnect pattern including a plurality of bulk conductor regions, each bulk conductor region disposed parallel to said rows and associated with a set of energy storage elements, with each bulk conductor region including a plurality of positive terminal contacts joined to said positive terminals of said associated set of energy storage elements using a mechanical joint and a plurality of negative terminal contacts joined to said negative terminals of said associated set of energy storage elements using said mechanical joint;
wherein said interconnect pattern couples said plurality of energy storage elements into a single electrical module including both parallel-connected and series-connected sub-divisions of said plurality of energy storage elements.

2. The energy storage module of claim 1 wherein each energy storage element can produce an atypical overcurrent and further including a neck portion coupling each terminal contact to its associated bulk conductor region, each said neck portion defining a flexible fusible link that fuses when conducting said atypical overcurrent.

3. The energy storage module of claim 1 wherein said conductive layer is constructed of a first metal and wherein said contact terminals are plated with a second metal different from said first metal.

4. The energy storage module of claim 3 wherein said mechanical joint includes a spot weld connection between said terminal contact and its associated terminal.

5. The energy storage module of claim 4 wherein said conductive layer is constructed of a first metal and wherein said contact terminals are plated with a second metal different from said first metal.

6. The energy storage module of claim 5 wherein said mechanical joint includes a spot weld connection between said terminal contact and its associated terminal.

7. The energy storage module of claim 1 further comprising a battery module circuit including a processor, memory, and transceivers and wherein said flexible printed circuit interconnects said processor, memory, and transceivers.

8. The energy storage module of claim 7 further comprising a plurality of sensors associated with a set of said energy storage elements and wherein said flexible printed circuit includes a plurality of low-voltage communication signal paths coupling said battery module circuit to said plurality of sensors.

9. An energy storage module, comprising:
a matrix of energy storage elements orderly arranged and secured into a plurality of N number of rows and M number of columns, N greater than or equal to M, each energy storage element of said matrix including a surface face defining both a positive terminal and a negative terminal; and
a flexible printed circuit having one or more flexible conductive layers disposed between alternating flexible insulating layers, each said layer having a thickness less than 0.1 mm, each said conductive layer defining a flexible interconnect pattern, said interconnect patterns collectively including a plurality of bulk conductor regions, each bulk conductor region disposed parallel to said rows and associated with a set of energy storage elements, with each bulk conductor region including a plurality of positive terminal contacts joined to said positive terminals of said associated set of energy storage elements using a mechanical joint and a plurality of negative terminal contacts joined to said negative terminals of said associated set of energy storage elements using said mechanical joint;
wherein said interconnect patterns collectively couple said plurality of energy storage elements into a single electrical module including both parallel-connected and series-connected sub-divisions of said plurality of energy storage elements.

10. An energy storage module, comprising:
a matrix of energy storage elements orderly arranged and secured into a plurality of N number of rows and M number of columns, N greater than or equal to M, each energy storage element of said matrix including a surface face defining both a positive terminal and a negative terminal; and
a flexible printed circuit having a first region including a flexible conductive layer disposed between a pair of flexible insulating layers and a second region including a plurality of conductive layers disposed between alternating flexible insulating layers, each said conductive layer defining a flexible interconnect pattern, said interconnect pattern of said first region providing terminal connection structures including a plurality of positive terminal contacts joined to said positive terminals of said associated set of energy storage elements using a mechanical joint and a plurality of negative terminal contacts joined to said negative terminals of said associated set of energy storage elements using said mechanical joint, and said interconnect patterns of said second region collectively including a plurality of bulk conductor regions, each bulk conductor region disposed parallel to said rows and associated with a set of energy storage elements, with each bulk conductor region electrically communicated to said first region;
wherein said interconnect patterns collectively couple said plurality of energy storage elements into a single electrical module including both parallel-connected and series-connected sub-divisions of said plurality of energy storage elements.

11. An energy storage module, comprising:
a matrix of energy storage elements orderly arranged and secured into a plurality of N number of rows and M number of columns, N greater than or equal to M, each energy storage element of said matrix including a first surface face defining a positive terminal and second surface face defining a negative terminal; and
a pair of flexible printed circuits, each flexible printed circuit having a flexible conductive layer disposed between a pair of flexible insulating layers, each said layer having a thickness less than 0.1 mm, said conductive layer defining a flexible interconnect pattern, said interconnect pattern including a plurality of bulk conductor regions, each bulk conductor region disposed parallel to said rows and associated with a set of energy storage elements, with each bulk conductor region including a plurality of terminal contacts;
wherein said terminals of said associated set of energy storage elements are electrically communicated to one of said flexible printed circuits using a plurality of mechanical joints between said terminals and said terminal contacts.

12. A method of interconnecting a matrix of energy storage elements orderly arranged and secured into a plurality of N number of rows and M number of columns, N greater than or equal to M, each energy storage element of said matrix including one or two surface faces defining a positive terminal and a negative terminal, comprising:
a) overlying all the terminals with one or two flexible printed circuits, one flexible printed circuit assembly for each face defining a terminal; and
b) mechanically joining said one or two flexible printed circuits to each terminal of each energy storage element creating an electrical coupling of said flexible printed circuit boards to the matrix of energy storage elements.
